(19) United States
(12) Patent Application Publication
(10) Pub. No.: US 2013/0305270 A1
(43) Pub. Date: Nov. 14, 2013

(54) SYSTEM AND METHOD FOR RATING A MEDIA FILE

(71) Applicants: Eran POLACK, Tel Aviv (IL); Amit Farbman, Tel Aviv (IL)

(72) Inventors: Eran POLACK, Tel Aviv (IL); Amit Farbman, Tel Aviv (IL)

(73) Assignee: sCoolTV, Inc., Dover Kent, DE (US)

(21) Appl. No.: 13/466,136

(22) Filed: May 8, 2012

(51) Int. Cl. H04N 21/24

(52) U.S. Cl. 725/13

(57) ABSTRACT

The subject matter discloses a method comprising obtaining a viewer's feedback from a viewer of a media file, determining a rating value according to said viewer's feedback and transmitting the rating value to a server. The method also comprises receiving an accumulated rating value of the media file from the server and displaying said accumulated rating value to reflect the viewer's feedback.

### FIELD OF THE INVENTION

The subject matter relates generally to a reviewing a media file and more specifically a method of rating a media file.

### BACKGROUND OF THE INVENTION

Modern media players enable users to access a media file and view it. The user can watch the video, pause it, stop it, fast forward, rewind, skip ahead to a different media file or return to a previous media file. Certain media players allow users to add a rating for a video, by using an input device such as a mouse to click on an approval rating button on a display device. Such rating later appears on a webpage that displays the media file, for example YouTube. Other viewers of the same media file will review the accumulated ratings and feedback provided by multiple viewers of the media file.

In TV shows, especially shows that include a contest of any kind, it is common to suggest home viewers to vote for a specific competitor of the contest, for example a singer in a singing contest. Such votes are likely to be provided by the home viewers using an SMS message, email message, a phone call and the like.

### SUMMARY

It is an object of the subject matter to disclose a method comprising obtaining a viewer's feedback from a viewer of a media file, determining a rating value according to said viewer's feedback and transmitting the rating value to a server.

In some cases, the method further comprises receiving an accumulated rating value of the media file from the server and displaying said accumulated rating value to reflect the viewer's feedback.

In some cases, the method further comprises comparing the viewer's feedback with an itemized feedback located in a list of itemized feedbacks and determining the rating value according to a match between the viewer's feedback and an item in the list of itemized feedbacks.

In some cases, the method further comprises updating the rating data according to a new viewer's feedback.

In some cases, the rating value comprises a positive rating and a negative rating, increase of the positive rating results in the decrease of the negative rating.

In some cases, the viewer's feedback is an audio collection device, a motion sensing device and an image collection device.

In some cases, obtaining the viewer's feedback as an analog signal and converted to a digital signal. In some cases, the viewer's feedback is obtained as a digital signal.

It is another object of the subject matter to disclose a method for determining an accumulated rating of a media file, comprising receiving a plurality of rating values from a plurality of computerized devices associated with watching the media file, said plurality of rating values reflect viewer's feedbacks of viewers of the media file; accumulating the plurality of rating values to determine an accumulated rating value of the media file; transmitting said accumulated rating value of the media file to the plurality of computerized devices associated with watching the media file.

It is another object of the subject matter to disclose a system, comprising: a feedback collector for collecting a viewer's feedback; a computerized device processor for obtaining a rating value for the viewer's feedback; a computerized device transmitter for transmitting the rating value to a server; a computerized device display for displaying the media file and the rating value associated with the media file.

In some cases, the system further comprises a digital signal processor for converting the viewer's feedback from an analog signal to a digital signal. In some cases, the feedback collector is an audio collection device, a motion sensing device, and an image collection device.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a system for adding a viewer's feedback to a media file, according to some exemplary embodiment of the subject matter;

FIG. 2 shows a method of adding a viewer's feedback to a media file, according to some exemplary embodiment of the subject matter;

FIG. 3A shows obtaining an audio viewer's feedback, according to some exemplary embodiment of the subject matter;

FIG. 3B shows obtaining a motion viewer's feedback, according to some exemplary embodiment of the subject matter;

FIG. 3C shows obtaining an image viewer's feedback, according to some exemplary embodiment of the subject matter; and,

FIG. 4 shows a display of the system for adding the viewer's feedback to a media file, according to some exemplary embodiment of the subject matter.

### DETAILED DESCRIPTION

The present subject matter discloses a method and a system for rating a media file viewed by a viewer, such as a TV show or a segment of a TV show. The method further displaying a viewer's feedback with a media file being played on a computerized device, such as a television, a laptop computer, or a smartphone. The method comprises obtaining the viewer's feedback through a feedback collector, which is connected to the computerized device. The viewer's feedback is a sensory reaction the viewer has to the contents of the media file being played on the computerized device. The viewer's feedback is converted into a rating value and the rating value is transmitted to a central unit, such as a server, that receives multiple feedbacks from multiple viewers. Some of the feedbacks received by the central unit may be non-sensory, such as SMS messages.

The subject matter also comprises a method for determining an accumulated rating value of a media file according to a viewer's feedback received from a plurality of computerized devices. The central unit may then determine an accumulated rating value according to the multiple feedbacks from the multiple viewers. The central unit may comprise a server processor, which updates the accumulated rating value frequently. The accumulated rating value may be updated in a real-time manner. Updating the accumulated rating value may be performed after receiving a new viewer's feedback from a computerized device on which the media file is displayed. The update accumulated rating data is transmitted back to the computerized device by a transmitter and displayed with the media file on a display of the computerized device. The updated rating data displayed on the computerized device display reflects the viewer's feedback collected by the feedback collector.

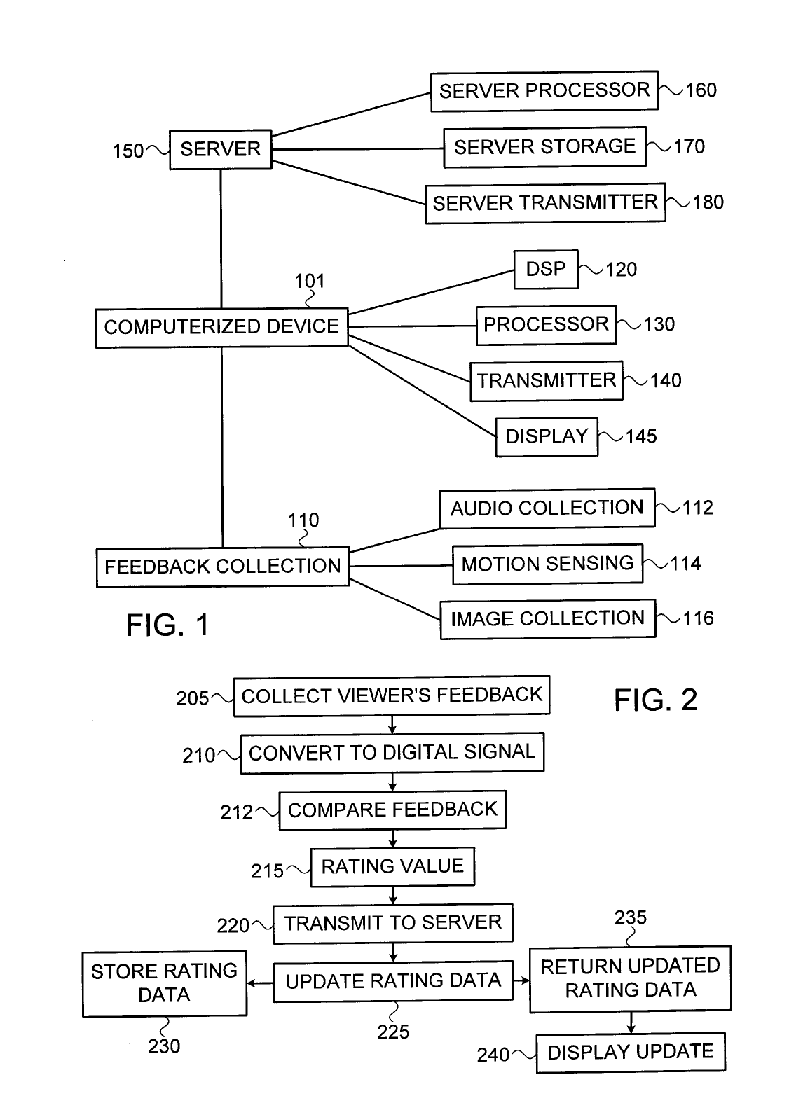

FIG. 1 shows a system for adding a viewer's feedback to a media file, according to some exemplary embodiment of the subject matter. The system comprises a server 150 connected to a computerized device 101. The computerized device 101 comprises a computerized device display 145 on which the viewer watches the media file. The computerized device display 145 may also display the viewer's feedback. The computerized device 101 comprises a feedback collector 110, which collects the viewer's feedback. The feedback collector 110 may be continuously collecting analog samples or digital samples to obtain continuous viewer's feedback. The viewer's feedback may alternatively be limited in time. The feedback collector 110 may comprise an audio collection device 112, a motion sensing device 114, an image collection device 116, or a combination of the three. The audio collection device 112 collects the viewer's audio responses as the viewer's feedback. For example, if the viewer makes a booing sound then the audio collection device 112 collects the booing sound as the viewer's feedback. The motion sensing devise 114 collects the viewer's movement as the viewer's feedback. For example, the viewer dances when she approves of something she sees in the media file, the motion sensing device 114 collects the moves of her performance. The image collection device 116 collects an image of the viewer as the viewer's feedback. For example, the viewer points two thumbs up at the image collection device 116, which takes the viewer's image in that position.

The feedback collector 110 collects the viewer's feedback. The feedback collected by the feedback collector 110 may be of an analog signal or a digital signal. In some exemplary embodiments of the subject matter, the computerized device 101 may comprise a digital signal processor 120. In such an exemplary embodiment, the feedback collector 110 collects feedback comprising an analog signal. The analog signal is transmitted to the digital signal processor 120. The digital signal processor 120 receives the analog signal of the viewer's feedback and converts the analog signal into a digital signal. The conversion into the digital signal occurs when the digital signal processor 120 obtains discrete samples of the analog signal and constructs a digital signal that represents the analog signal. The digital signal becomes the viewer's feedback with which the rating value can be assigned. The digital signal processor 120 then transfers the digital signal to a computerized device processor 130.

The computerized device processor 130 comprises a list of itemized feedbacks with a rating value for each itemized feedback in the list. The itemized feedbacks are viewer's feedbacks that the computerized device processor 130 recognizes and is enabled to associate with the rating value. The rating value is a value by which the rating data is changed with respect to the viewer's feedback. For example, the rating value for a viewer's feedback of clapping 3 times is an increase of 3 for the positive rating. The clapping 3 times may also cause a decrease of 3 for a negative rating associated with the media file.

The computerized device processor 130 may comprise a separate list of itemized feedbacks for different sensory reactions being recorded. For the audio collection device 112, the list of itemized feedback may comprise different types of items. An item in the list of itemized feedback may be audio samples such as audio samples of clapping, booing, hooraying and the like. For the motion sensing device 114, the list of itemized feedback may comprise movement samples, such as dancing, shaking of a body parts or limbs, for example a head, jumping around, and the like. For the image collection device 116, the list of itemized feedback may comprise image samples, such as images of thumb up, thumb down, smiles, frowns, and the like. The computerized device processor 130 may comprise an itemized list comprising all three types of feedbacks.

The computerized device processor 130 may receive the viewer's feedback from the digital signal processor 120 or directly from the feedback collector 110. The computerized device processor 130 may also be used to compare the viewer's feedback with the itemized feedbacks stored at the list of itemized feedbacks. If there is a match between the viewer's feedback and the itemized feedback, then the computerized device processor 130 assigns the associated rating value to the viewer's feedback. After the rating value is assigned to the viewer's feedback, a computerized device transmitter 140 transmits the rating value to the server 150 to update the rating data.

The server 150 comprises a server processor 160, which receives the rating value from the computerized device transmitter 140. The server processor 160 then updates the rating data of the media file based on the rating value received from the computerized device 101. The updated rating data may be available to be viewed by the other viewers of the media file. The server 150 may also store the updated rating data in a server storage unit 170 to make the updated rating data available for future viewers. After the server processor 160 updates the rating data of the media file, the updated rating data is transmitted to the computerized device processor 130 by a server transmitter 180.

The computerized device processor 130 obtains the updated rating data received from the server transmitter 180 and updates the rating display data on the computerized device display 145. In some cases, increase in the positive rating results in the decrease of the negative rating and vice versa. For example, if the updated rating data comprises a positive rating and a negative rating and the positive rating was reduced from 60% to 54% and the negative rating was increased from 40% to 46%, the computerized device display 145 displays this change by reducing the height of a positive rating bar display and altering the number near the positive rating bar display to reflect the reduction in the positive rating. The computerized device display 145 may also display the increase in the height of a negative rating bar display and increasing the displayed number near the negative rating bar display to reflect the increase in the negative rating.

FIG. 2 shows a method for obtaining and displaying the viewer's feedback, according to exemplary embodiments of the subject matter. In step 205, the feedback collector 110, from FIG. 1, collects the viewer's feedback according to the sensory reactions of the viewer and which sensory reaction the input device is capable of recording.

Step 210 provides for converting an analog signal representing the viewer's feedback collected by the feedback collector 110 into a digital signal. Such conversion may be performed by a digital signal processor 120 that converts the analog signal received from the feedback collector 110 into a digital signal by taking discrete samples of the analog signal and reconstructing a digital signal. Step 212, provides for comparing the viewer's feedback with itemized feedbacks located in the list of itemized feedbacks. The computerized device processor 130 looks for a matching itemized feedback. If the computerized device processor 130 finds a matching itemized feedback, the computerized device processor 130 continues to step 215.

In step 215, the computerized device processor 130 assigns the rating value of the itemized feedback to the viewer's feedback. For example, the viewer's feedback is a motion recording of the viewer jumping up and down, recorded by the motion sensing device 114. The motion is matched with an itemized feedback of dancing. The itemized feedback comprises a rating value of an increase value of 6 to the positive rating and a decrease of 6 to the negative rating. The rating value is attached to the viewer's feedback, since a match was made.

In step 220, the computerized device transmitter 140 transmits the rating value to the server 150, which then uses the rating value to update the rating data of the media file associated with the rating value transmitted by the computerized device transmitter 140. For example, if the viewer's feedback is a motion of the viewer shaking his head, which the computerized device processor 130 matches as having a rating value of positive 5, the computerized device transmitter 140 sends the server 150 a rating value of positive 5 to the viewer feedback.

In step 225, the server processor 160 updates the rating data of the media file to reflect the rating values received from the computerized device 101. For example, if the rating value transmitted by the computerized device transmitter 140 is of negative 5, the server processor 160 updates the rating data so that the negative rating increases by 5 and the positive rating decreases by 5. If the previous rating data was that the positive rating was 80% and the negative rating was 20%, then the updated rating value is a positive rating of 75% and the negative rating is be 25%. In some cases, the server processor 160 considers more than one rating value from more than one computerized device, such as the computerized device 101. In such a case, the server processor 160 may accumulate the data received from the than one computerized device in order to update the rating value of the media file.

In some cases, the server 150 provides for determining an accumulated rating of a media file. In such a case, the server receives a plurality of rating values from a plurality of computerized devices associated with watching the media file, said plurality of rating values reflect viewer's feedbacks of viewers of the media file. The server 150 then accumulating the plurality of rating values to determine an accumulated rating value of the media file. Then, the server 150 transmitting the accumulated rating value of the media file to the plurality of computerized devices associated with watching the media file.

In step 230, the server processor 105 stores the updated rating data in a server storage unit 170 to make the updated rating data available for other viewers of the media file. In Step 235, the server transmitter 180 transmits the updated rating data to the computerized device 101. The server transmitter 180 sends the updated rating data so the computerized device processor 130 updates the computerized device display 145 so the displayed rating data matches the rating data. In step 240, the computerized device display 145 displays the updated rating data to represent the changes made by the rating value. From the above example, where the updated rating data received by the computerized device processor 130 is updated so the positive rating is 75% and the negative rating is 25%, the computerized device display 145 displays this updated rating data on the display device, for example by changing the height of the positive rating bar display and the negative rating bar display to match the updated rating data.

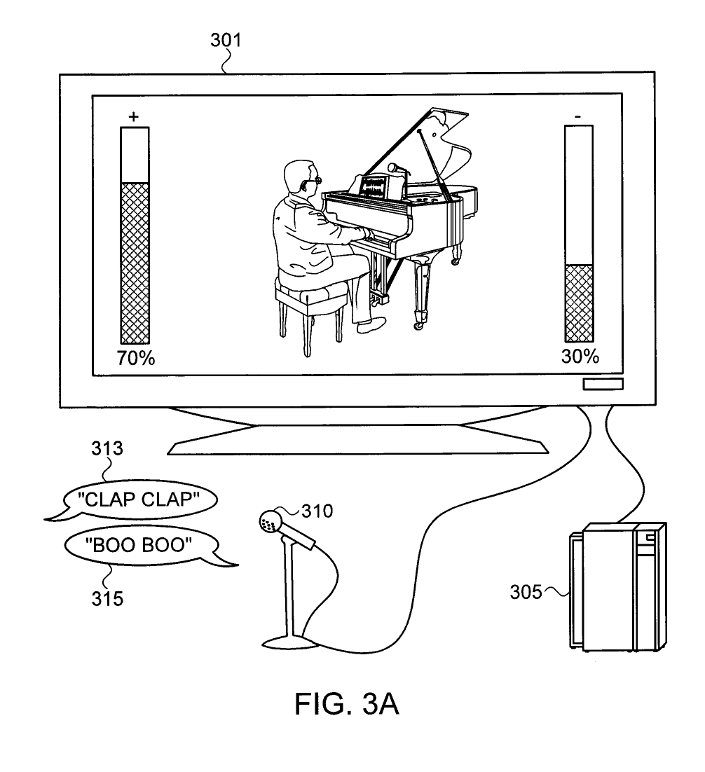

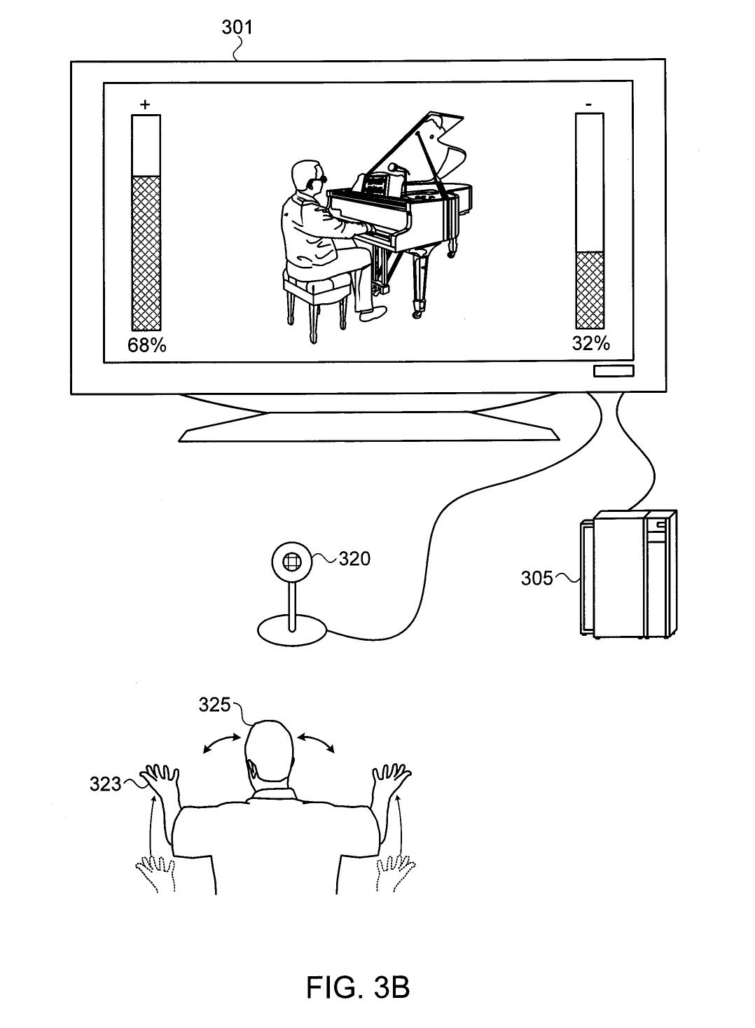

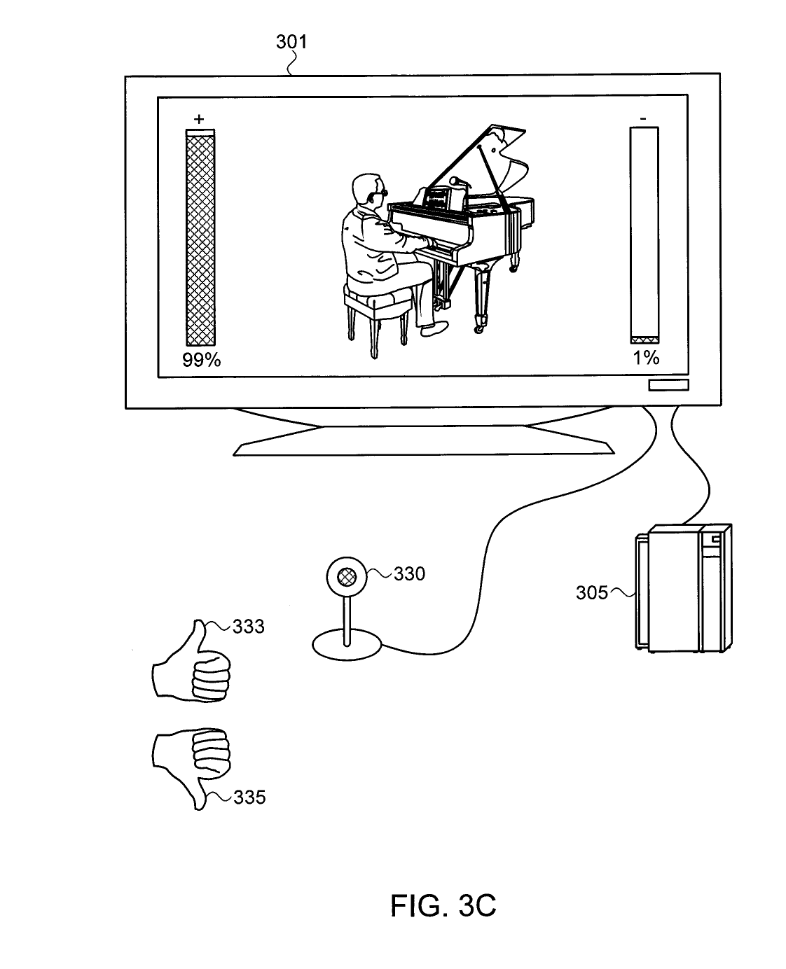

FIGS. 3A, 3B and 3C show examples of obtaining the viewer's feedback according to exemplary embodiments of the subject matter. FIG. 3A shows a computerized device 301 connected to an audio collection device 310, which is an example of the feedback collector 110 shown in FIG. 1. For example, the audio collection device 310 collects the viewer making clapping sounds 313. The clapping sounds 313 are the viewer's feedback which the audio collection device 310 transfers to the digital signal processor 120, from FIG. 1, which converts the viewer's feedback into a digital signal form of the viewer's feedback. In some exemplary embodiments, the audio collection device 310 is a digital device and does not require the digital signal processor 120, as the audio is already collected in a digital format. The digital signal is sent to the computerized device processor 130 which compares the digital signal of the viewer's feedback with the itemized feedbacks for the itemized feedback of clapping. The digital signal processor 120 matches the viewer's feedback with the itemized feedbacks and assigns the itemized feedback's rating value, such as the rating value of plus 5% to the positive rating and a minus 5% to the negative rating. The rating value is transmitted by the computerized device transmitter 140 to a server 305. In some cases, the itemized feedback list is stored at the server 150 and the computerized device transmitter 140 only sends the collected signal to the server 150 that compares the collected signal with the itemized list to determine the rating value.

The server 305 comprising of a server processor 160, from FIG. 1, received the rating value and updates the rating data. For example, the rating data prior to the viewer's feedback was the rating data of 70% in the positive rating and 30% in the negative rating. The server processor 160 receives the rating value from the computerized device transmitter 140 and updates the rating data so that the positive rating is increased to 75% and the negative rating is decreased to 25%, to reflect he newly received rating value. The updated rating data is stored in the server storage unit 170 and transmitted by the server transmitter 180 to the computerized device 301. The computerized device processor 130 receives the updated rating value. The updated rating data is displayed on the computerized device display 145. The computerized device display shows the updated rating data, which shows that 75% of the viewers watching the media file approve of the media file and 25% of the viewers watching the media file disapprove of the media file. The viewer's feedback would be updated in the same manner if the viewer's feedback was disapproval, for example making the noise of booing 315.

FIG. 3B shows the computerized device 301 connected to a motion sensing device 320 as the feedback collector 110 for obtaining the viewer's feedback, according to exemplary embodiments of the subject matter. The motion sensing device 320 collects the viewer's motions as the viewer's feedback and transfers the viewer's feedback to the computerized device 301 in the same manner as the audio collection device 310 transferred the viewer's feedback in FIG. 3A. For example, the motion sensing device 320 may collect a viewer's feedback comprising of motions of waiving hands in the air 323 as approval of the media file or shaking of a head 325 as disapproval. After the motion is collected by the motion sensing device 320, the viewer's feedback follows the same method to update the rating data and display it on the computerized device 301 as disclosed above.

FIG. 3C shows the computerized device 301 is connected to an image collection device 330 as the feedback collector 110 for obtaining the viewer's feedback, according to exemplary embodiment of the subject matter. For example, the image collection device 330 takes continuous images of the viewer watching the media file. The image collection device 330 collects an image of the viewer giving a thumb up 333. The thumb up image 333 is the viewer's feedback. Another example of the viewer's feedback is a thumb down image 335 captured by the image collection device 330. The feedback is sent to the digital signal processor 120, which converts the image from an analog image into a digital image through digital image processing. In some exemplary embodiments, the image collection device 330 is a digital device and does not require the digital signal processor 120, as the images are already collected in a digital format. The viewer's feedback is converted into the rating value and used to update the rating data in the same manner disclosed above.

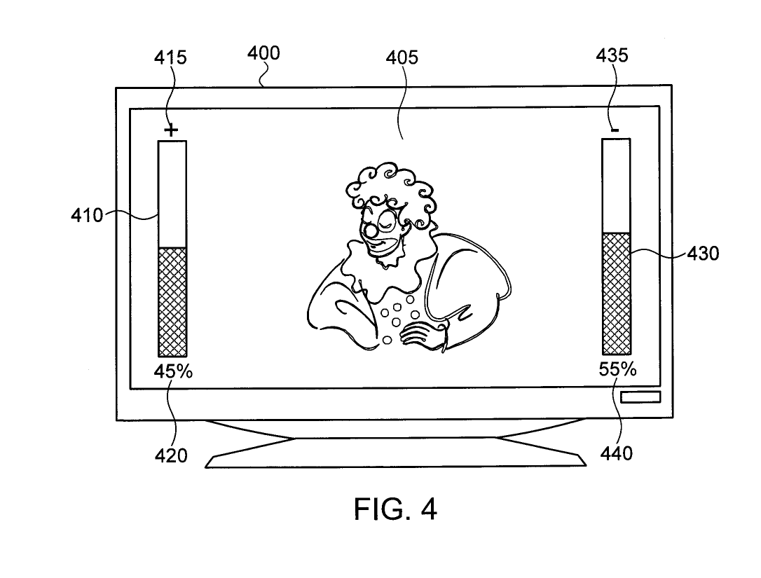

FIG. 4 shows a computerized device display 400 according to exemplary embodiment of the subject matter. The computerized device display 400 displays the media file 405 being viewed by the viewer. The media file 405 may be displayed in the center of the computerized device display 400. The positive rating and the negative rating may be displayed on the right and left side of the computerized device display 400. The positive rating will comprise of a positive recognizing icon 415, which may be a symbol or word, for example a plus symbol or the word “Approve.” The positive rating may be displayed as a positive rating bar display 410 that shows a visual representation of the positive rating. The positive rating may have a positive numerical display 420 of the positive rating, for example a display of the positive numerical display 45%. The negative rating may also have such displays as a negative recognizing icon 435, for example a minus symbol or the word “Disapprove.” The negative rating may be displayed as a visual through a negative rating bar display 430, and a negative numerical display 440, for example the number 55%. The rating display may be updated every time the computerized device 101 receives the updated rating data, For example, when the computerized device 101 receives from the server 150 the updated rating data of an increase of 8 to the positive rating and a decrease of 8 to the negative rating. The computerized device display 400 will update the rating display to match the updated rating data received from the server 150. The positive rating bar display 410 increases to show the change increase in the positive rating, and the positive numerical display 420 changes the number 45% to show the increase of 8 resulting in the positive numerical display of 53%. Likewise, the negative rating bar display 430 will change to show a reduction in the negative rating, and the negative numerical display 440 will change from 55% to 47%.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

What is claimed is:

1. A method comprising:
obtaining a viewer's feedback from a viewer of a media file;
determining a rating value according to said viewer's feedback;
transmitting the rating value to a server.

2. The method of claim 1, further comprises receiving an accumulated rating value of the media file from the server and displaying said accumulated rating value to reflect the viewer's feedback.

3. The method of claim 1, further comprises comparing the viewer's feedback with an itemized feedback located in a list of itemized feedbacks and determining the rating value according to a match between the viewer's feedback and an item in the list of itemized feedbacks.

4. The method of claim 1, further comprises updating the rating data according to a new viewer's feedback.

5. The method of claim 1, wherein:
the rating value comprises a positive rating and a negative rating;
increase of the positive rating results in the decrease of the negative rating.

6. The method of claim 1, wherein the viewer's feedback is an audio collection device, a motion sensing device and an image collection device.

7. The method of claim 1, wherein obtaining the viewer's feedback as an analog signal and converted to a digital signal.

8. The method of claim 1, wherein obtaining the viewer's feedback as a digital signal.

9. A method for determining an accumulated rating of a media file, comprising:
receiving a plurality of rating values from a plurality of computerized devices associated with watching the media file, said plurality of rating values reflect viewer's feedbacks of viewers of the media file;
accumulating the plurality of rating values to determine an accumulated rating value of the media file;
transmitting said accumulated rating value of the media file to the plurality of computerized devices associated with watching the media file.

10. A system, comprising:
a feedback collector for collecting a viewer's feedback;
a computerized device processor for obtaining a rating value for the viewer's feedback;
a computerized device transmitter for transmitting the rating value to a server;
a computerized device display for displaying the media file and the rating value associated with the media file.

11. The system of claim 10, further comprises a digital signal processor for converting the viewer's feedback from an analog signal to a digital signal.

12. The system of claim 10, wherein the feedback collector is an audio collection device, a motion sensing device, and an image collection device.
